(19) United States
(12) Patent Application Publication
(10) Pub. No.: US 2007/0186750 A1
(43) Pub. Date: Aug. 16, 2007

(54) Apparatus and method for composing music in a portable terminal

(75) Inventor: Soo-Hyung Zhang, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/656,333

(22) Filed: Jan. 22, 2007

(30) Foreign Application Priority Data
Jan. 20, 2006 (KR) 10-2006-0006482

(51) Int. Cl. G10H 7/00; A63H 5/00; G04B 13/00

(52) U.S. Cl. 84/609

(57) ABSTRACT

The present invention relates to an apparatus and a method for composing music in a portable terminal. A frequency of a sound input through a microphone is analyzed. A musical scale is distinguished with the analyzed frequency. A musical note is written with the distinguished musical scale. Thus, a user can easily compose music with a musical scale recognition interface capable of recognizing a musical scale.

### PRIORITY

This application claims priority under 35 U.S.C. §119 to an application entitled “Apparatus And Method For Composing Music In A Portable Terminal” filed in the Korean Intellectual Property Office on Jan. 20, 2006 and assigned Serial No. 2006-6482, the contents of which are incorporated herein by reference.

### BACKGROUND OF THE INVENTION

1. Field of the Invention

The present invention relates to an apparatus and a method of composing music in a portable terminal, and particularly to an apparatus and a method for composing music using musical scale recognition in a portable terminal.

2. Description of the Related Art

Portable terminals are widely used due to the development of wireless communications and portable convenience. Along with the trend toward being light weight and small-sized, the various functions of portable terminals attract more and more attention.

In addition to the typical call communication function, advanced functions such as listening to music using a MPEG-Layer 3 player, playing VOD (Video On Demand) files, or photographing and storing images are implemented in portable terminals.

Also, peripheral devices attached or embedded in the mobile communication terminal are being developed. For example, some peripheral devices include an attachable or built-in digital camera module and a TV reception module for DMB (Digital Multimedia Broadcasting) reception.

One of the more popular functions is the music function. Users enjoy composing music as well as listening to music. However, a user who may be uneducated in the technical aspects of music composition has trouble in spite of the user's need and desire to compose. Further, it is difficult to annotate a musical motif that unexpectedly occurs to the user.

A conventional terminal provides a music performance function using a keypad or a function of notating the performed music. This is not convenient because the user must use a keypad when performing the musical motif. If the user does not have ability to annotate a musical motif, the user can not make the full use of the music performance and composition functions using the keypad.

Also, the function of reading and notating a MP3 file is provided, but it does not meet the user's creative desire.

Therefore, there is a need to provide an apparatus and a method for composing music and for recognizing input sound as a musical scale in a portable terminal.

### SUMMARY OF THE INVENTION

An aspect of the present invention is to provide an apparatus and a method for composing music in a portable terminal.

Another aspect of the present invention is to provide an apparatus and a method for recognizing input sound as a musical scale in a portable terminal.

A further aspect of the present invention is to provide an apparatus and a method for writing a music note through the recognition of an input sound as a musical scale in a portable terminal.

According to one aspect the present invention for achieving the above aspects, a method for composing music with musical scale recognition in a portable terminal includes analyzing a frequency of a sound input through a microphone, distinguishing a musical scale with the analyzed frequency, and writing a music note using the distinguished musical scale.

According to another aspect of the present invention for achieving the above aspects, an apparatus of composing music in a portable terminal includes a musical scale recognition module for analyzing a frequency of a sound input through a microphone and outputting musical scale data, and a controller for writing a musical note with the musical scale data received from the musical scale recognition module.

### BRIEF DESCRIPTION OF THE DRAWINGS

The above and other objects, features, and advantages of the present invention will become more apparent from the following detailed description when taken in conjunction with the accompanying drawings in which:

FIG. 1 illustrates a block diagram of a mobile communication terminal according to the present invention;

FIG. 2 illustrates a flowchart diagram showing a procedure of composing music in a portable terminal according to the present invention; and

FIG. 3 illustrates a screen shot in operating music composition mode according to the present invention.

### DETAILED DESCRIPTION OF THE PREFERRED EMBODIMENTS

Preferred embodiments of the present invention will be described below with reference to the accompanying drawings. In the following description, well-known functions or constructions are not described in detail not to obscure the present invention with unnecessary detail.

An apparatus and a method for writing a musical note by recognizing an input sound (e.g. humming) and displaying it on a musical scale in a portable terminal will be described. The method for analyzing sound includes, but is not limited to, wave analysis and frequency analysis. A method for recognizing a musical note using frequency analysis will be described herein.

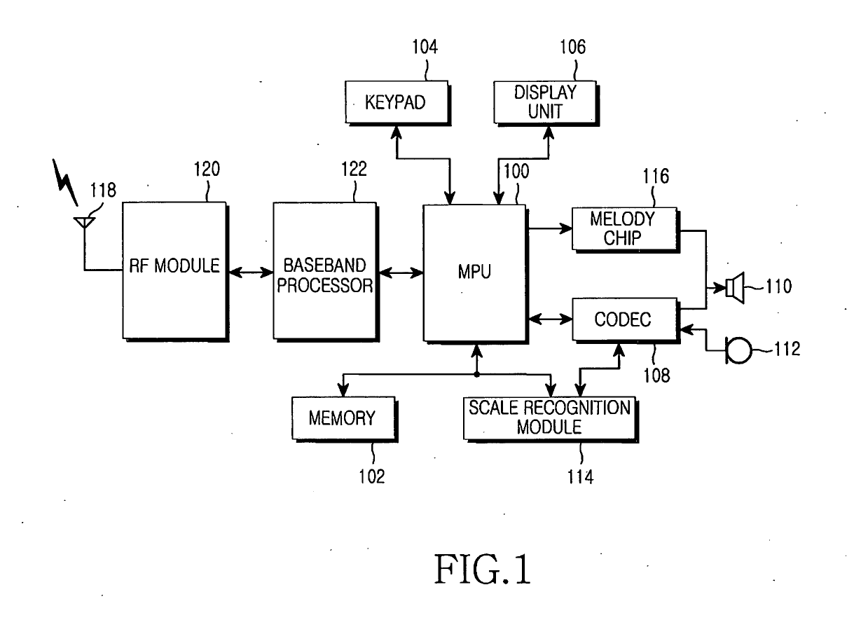

FIG. 1 is a block diagram of a mobile communication terminal according to the present invention. The portable terminal may include, but is not limited to, a cellular phone, a Personal Communication System (PCS), a Personal Data Assistant (PDA) and International Mobile Telecommunication-2000 (IMT2000). A general configuration of the above examples will be described.

Referring to FIG. 1, a Micro-Processor Unit (MPU) 100, acting as a controller, controls the overall operation of the portable terminal. For example, the MPU 100 is responsible for processing and controlling voice and data communications. In addition, the MPU 100 processes functions for recognizing a musical scale by distinguishing a frequency of sound input through a microphone and for writing a musical note using the recognized musical scale. A detailed description of the typical processing and controlling operation of the MPU 100 is understood by those skilled in the art.

Memory 102 includes a program memory, a data memory and a nonvolatile memory. The program memory stores software for controlling the overall operation of the portable terminal. The program memory may be a flash memory. The data memory stores temporary data being generated while performing all programs. The data memory may be Random Access Memory (RAM). The nonvolatile memory stores system parameters and various data to be kept, such as a phone book, an image data, etc. The nonvolatile memory may be an Electrically Erasable and Programmable Read Only Memory (EEPROM). The memory 102 includes a musical scale database for storing frequency information of each musical scale or note.

A keypad 104 can include numeric keys of digits 0-9 and a plurality of function keys, such as a MENU key, a CANCEL (REMOVE) key, an ENTER key, a TALK key, an END key, an internet connection key, navigation keys (▴/▾/ [symbol] / [symbol] ). The key input data corresponding to a key pressed by the user is transmitted to the MPU 100. A display unit 106 can include and display, but is not limited to, status information, limited number of characters, moving pictures and still pictures. The display unit 202 may be a Liquid Crystal Display (LCD).

A Coder-Decoder (CODEC) 108 connected to the MPU 100, a microphone 112, and a speaker 110 connected to the CODEC 108 are audio input/output units for use in voice communications. The MPU 100 produces Pulse Code Modulation (PCM) data and the CODEC 108 converts the PCM data into analog audio signals. The analog audio signals are output through the speaker 110. Also, the CODEC 108 converts analog audio signals received through the microphone 112 into PCM data and provides the MPU 100 with the PCM data.

A musical scale recognition module 114 recognizes a musical scale by analyzing a frequency of digital data received from the CODEC 108 and provides the MPU 100 with the recognized musical scale information. For example, the musical scale recognition module 114 can be implemented with a Digital Signal Processor (DSP) and can analyze a frequency by FFT (Fast Fourier Transform)-processing.

A melody chip 116 converts sound data of a predetermined format, for example, Musical instrument Digital Interface (MIDI) into analog signals and outputs them to the speaker 110. The melody chip 116 performs functions of playing and storing music (a melody) composed by a user.

Radio Frequency (RF) module 120 decreases a frequency of an RF signal received through an antenna 1.18 and provides the RF signal to a baseband processor 122. Also, the RF module 120 increases a frequency of a baseband signal provided from the baseband processor 122, and transmits the baseband signals through the antenna 118. The baseband processor 122 processes the baseband signals which are transmitted/received between the RF module 120 and the MPU 100. For example, for Code Division Multiple Access (CDMA) communication, the baseband processor 122 performs channel coding and spreading transmission data, and despreading and channel decoding for reception data.

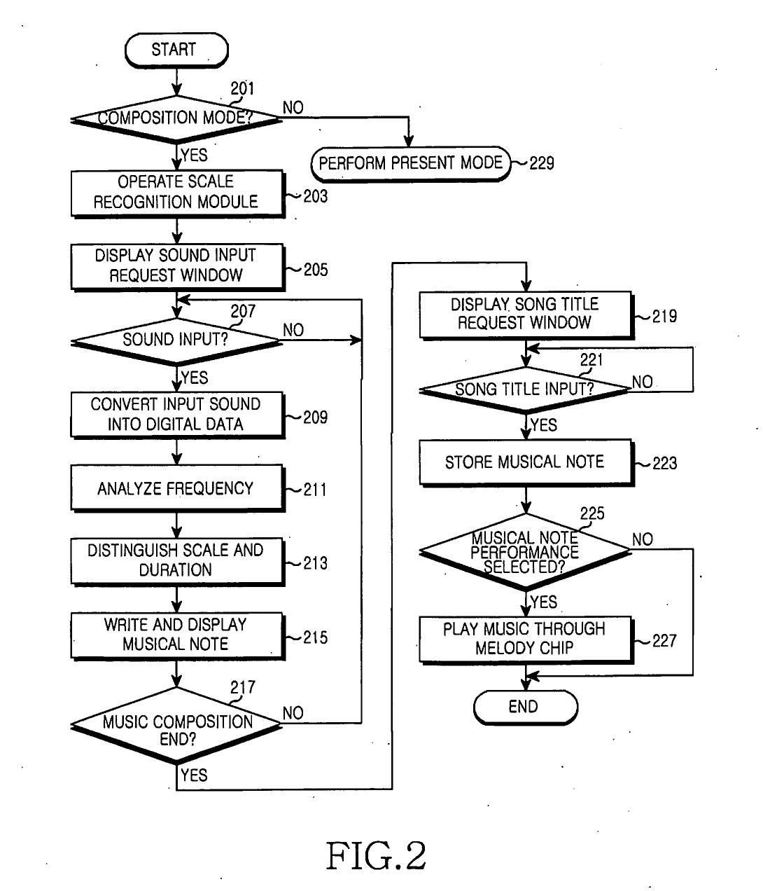

FIG. 2 illustrates a flowchart showing a procedure of composing music in a portable terminal according to the present invention.

Referring to FIG. 2, the portable terminal determines if a music composition mode is entered into by a user's key manipulation in step 201. If the music composition mode is not sensed, the portable terminal proceeds to step 225 to perform a present mode (e.g. a waiting mode or the like).

Upon sensing of the music composition mode, the portable terminal operates the musical scale recognition module 114 in step 203. In step 205, a sound input request window is displayed. A user inputs musical motif through a microphone, for example, by humming.

The portable terminal then determines if there is sound input through the microphone in step 207. Upon input of the sound, the portable terminal converts the input sound into digital data in step 209.

In step 211, the portable terminal analyzes a frequency of the input sound by processing the digital data in a predetermined scheme, for example, by FFT-processing.

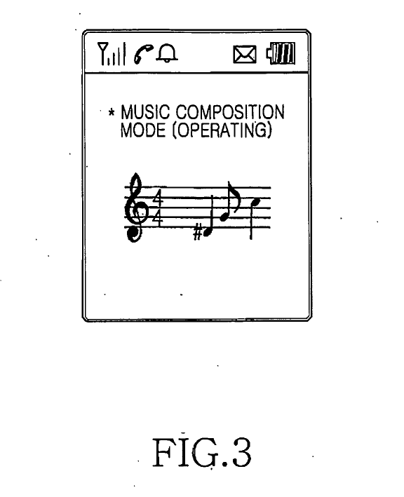

After analyzing the frequency of the sound, the portable terminal proceeds to step 213 to compare the analyzed frequency with a stored musical scale database and to distinguish a corresponding musical scale and duration thereof. In step 215, the portable terminal writes a musical note using the distinguished musical scale (e.g. do, re, mi, fa, sol, re, si) and the duration. The musical note is displayed on the display unit as illustrated in FIG. 3. Writing the musical note is equal to producing MIDI (Musical Instrument Digital Interface) data.

After distinguishing the musical scale of sound input through the microphone, the portable terminal proceeds to step 217 to determine if there is key input for ending the music composition mode. If key input for ending the music composition mode is not sensed, the portable terminal returns to step 207.

If the key input for ending the music composition is sensed, the portable terminal proceeds to step 219 to display a title input require window. In step 221, the portable terminal determines if there is input of a song title by the user's key manipulation. Upon input of the song title, the portable terminal stores the produced musical note or notes in the memory 102 in step 223. The musical note or notes can be used in various functions, for example, as a ring tone function, a morning call function, a ring-back tone function, etc. Also, the musical note or notes can be transmitted to another terminal with a Short Message Service (SMS).

After storing the musical note or notes, the portable terminal determines if a function of the musical note performance is selected by the user in step 225. When the musical note performance is selected, the portable terminal proceeds to step 227 to play music with the musical note or notes through the melody chip 116. Because the portable terminal includes a function of playing music composed by the user, the user can play and listen to music composed in the music composition mode.

FIG. 3 illustrates a screen shot in operating music composition mode according to the present invention. The portable terminal writes a musical note or notes using the distinguished musical scale and the duration. The screen shot illustrated in FIG. 3 are musical notes.

As described above, a user can easily compose music with a musical scale recognition interface capable of recognizing a musical scale (or a pitch). Also, the music composed by the user can be used as a ring tone, thereby adding additional user individuality to the mobile terminal.

Exemplary embodiments of the present invention can also comprise computer readable codes on a computer readable medium. The computer readable medium can comprise any data storage device that can store data that can be read by a computer system. Examples of a computer readable medium include magnetic storage media (such as, ROM, floppy disks, hard disks, among others), optical recording media (such as, CD-ROMs, or DVDs), and storage mechanisms such as carrier waves (such as, transmission through the Internet). The computer readable medium can also be distributed over network coupled computer systems so that the computer readable code is stored and executed in a distributed fashion. Also, functional programs, codes, and code segments for accomplishing exemplary embodiments of the present invention can be construed by programmers of ordinary skill in the art to which the present invention pertains.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. An apparatus for composing music in a portable terminal, comprising:
a musical scale recognition module for analyzing a frequency of an input sound and outputting musical scale data; and
a controller for writing a musical note with the musical scale data received from the musical scale recognition module.

2. The apparatus of claim 1, further comprising a display unit for displaying the written musical note on a musical scale.

3. The apparatus of claim 1, further comprising a memory for storing music data according to the written musical note.

4. The apparatus of claim 3, further comprising a melody chip for playing the music data.

5. The apparatus of claim 3, wherein the music data is Musical Instrument Digital Interface (MIDI) data.

6. The apparatus of claim 1, wherein the musical scale recognition module analyzes a frequency by FFT (Fast Fourier Transform)-processing.

7. The apparatus of claim 1, wherein the musical scale data has pitch and duration information.

8. A method of composing music in a portable terminal, comprising the steps of:
analyzing a frequency of an input sound;
distinguishing musical scale data by the analyzed frequency and outputting the musical scale data; and
writing a musical note with the musical scale data.

9. The method of claim 8, further comprising displaying the written musical note on a musical scale on a display unit.

10. The method of claim 8, further comprising creating music data with the written musical note.

11. The method of claim 10, wherein the music data is MIDI (Musical Instrument Digital Interface) data.

12. The method of claim 8, wherein the musical scale recognition module analyzes a frequency by FFT (Fast Fourier Transform) processing.

13. The method of claim 8, wherein the musical scale data has a pitch and duration.

14. An apparatus for composing music in a portable terminal, comprising:
a musical scale recognition module for analyzing a frequency of a sound input through a microphone and outputting musical scale data; and
a controller for writing a musical note with the musical scale data received from the musical scale recognition module.

15. The apparatus of claim 14, further comprising a display unit for displaying the written musical note on a musical scale.

16. The apparatus of claim 14, further comprising a memory for storing music data according to the written musical note.

17. The apparatus of claim 14, wherein the musical scale recognition module analyzes a frequency by FFT (Fast Fourier Transform)-processing.

18. A method of composing music in a portable terminal, comprising the steps of:
analyzing a frequency of a sound input through a microphone;
distinguishing musical scale data by the analyzed frequency and outputting the musical scale data; and
writing a musical note with the musical scale data.

19. A computer-readable recording medium having recorded thereon a program for composing music in a portable terminal including a musical scale recognition module for analyzing a frequency of an input sound and outputting musical scale data, and a controller for writing a musical note with the musical scale data received from the musical scale recognition module, comprising:
a first code segment, for analyzing a frequency of an input sound and outputting musical scale data; and
a second code segment, for writing a musical note with the musical scale data received from the musical scale recognition module.
